(19) United States
(12) Patent Application Publication
(10) Pub. No.: US 2020/0062252 A1
(43) Pub. Date: Feb. 27, 2020

(54) METHOD AND APPARATUS FOR DIAGONAL LANE DETECTION

(71) Applicant: GM GLOBAL TECHNOLOGY OPERATIONS LLC, DETROIT, MI (US)

(72) Inventors: Jeffrey S. Parks, Ann Arbor, MI (US); Loren J. Majersik, Salt Lake City, UT (US); Chris C. Swoish, Lapeer, MI (US)

(21) Appl. No.: 16/108,215

(22) Filed: Aug. 22, 2018

(51) Int. Cl. B60W 30/12; G06F 17/30; B62D 15/02; G05D 1/02; G01C 21/36

(52) U.S. Cl. CPC B60W 30/12; G06F 17/30241; B62D 15/025; G05D 1/0212; B60W 2710/20; G01C 21/36; G05D 2201/0213; B60W 2550/14; G05D 1/0231

(57) ABSTRACT

The present application generally relates to vehicle control systems and an apparatus and methods to detect diagonal lane markers. In particular, the method detects a first and second lane marker, compares those lane markers against expected lane marker values. If one of the detected lane markers deviates from an expected value by an amount greater than a threshold, the method is operative to determine if a previous lane marker detection was within the threshold and to generate a vehicle trajectory in response to the non-deviating marker and an expected marker.

### BACKGROUND

### Field of the Technology

The present disclosure relates to vehicles controlled by automated driving systems, particularly those configured to automatically control vehicle steering, acceleration, and braking during a drive cycle without human intervention. In particular, the present disclosure teaches a system and method for detecting lane markers, distinguishing a diagonal lane marker and generating a vehicle trajectory in response to a non-diagonal lane marker.

### Background Information

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Vehicle control systems are operative to determine the surrounding environment through a number of sensors, antennas, and detectors on the vehicle. Global positioning system data and stored or transmitted map data may be used to determine a proximate location and data from other sensors is used to determine a location with respect to surrounding objects, either static or dynamic. For example, the vehicle control system may use one or more cameras to detect painted lane markers to determine the vehicle location within the lane. However, sometimes these painted lane markers are missing or are indicative of false information. Shadows or old lane lines painted across the host lane can cause the camera and cause lane excursions from Lane Centering Control. It would be desirable to overcome these problems to ensure that vehicle control systems are able to keep vehicles within the intended lanes.

### SUMMARY

Embodiments according to the present disclosure provide a number of advantages. For example, embodiments according to the present disclosure may enable independent validation of autonomous vehicle control commands to aid in diagnosis of software or hardware conditions in the primary control system. Embodiments according to the present disclosure may thus be more robust, increasing customer satisfaction.

In accordance with an aspect of the present invention, a method comprising receiving a map data, detecting a first lane heading, generating an expected first lane heading in response to the map data and a previous first lane heading, determining a first deviation between the first land heading and the expected first lane heading wherein the first deviation is less than a threshold value, detecting a second lane heading, generating an expected second lane heading in response to the map data and a previous second lane heading, determining a second deviation between the second land heading and the expected second lane heading wherein the second deviation is greater than a threshold value, generating a first vehicle heading in response to the first lane heading and the expected second lane heading, and controlling a vehicle steering in response to the first vehicle heading.

In accordance with another aspect of the present invention, an apparatus comprising a receiver for receiving a map data, a sensor for detecting a first lane marker and a second lane marker, a processor for calculating a first lane heading in response to the first lane marker and a second lane heading in response to the second lane marker, comparing the second lane heading to a previous second lane heading to generate a calibration factor, generating a vehicle heading in response to the first lane heading and the first map data in response to the calibration factor exceeding a threshold, and a controller for adjusting a vehicle steering in response to the vehicle heading.

In accordance with another aspect of the present invention, a method comprising receiving a first map data, detecting a first lane heading and a second lane heading, comparing the second lane heading to a previous second lane heading to generate a calibration factor, generating a vehicle heading in response to the first lane heading and the first map data in response to the calibration factor exceeding a threshold, and controlling a vehicle in response to the vehicle heading.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows is a diagram of an exemplary environment for application of the method and apparatus for diagonal lane detection.

FIG. 2 shows a block diagram illustrating an exemplary implementation of an apparatus 200 according for diagonal lane detection.

FIG. 3 shows a flow chart illustrating an exemplary implementation of a method for diagonal lane detection.

FIG. 4 shows a flow chart illustrating another exemplary method for diagonal lane detection.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

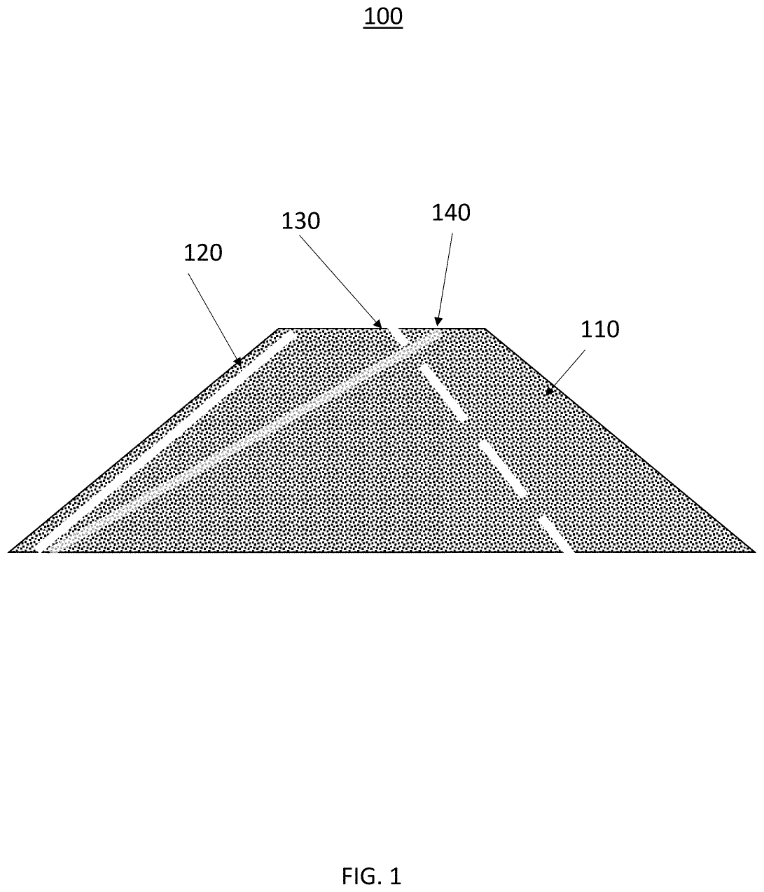

The present application teaches a method and system for detecting when a lane marker is moving diagonally across the lane while the other lane marker is moving straight. Referring now to the drawings, and more particularly to FIG. 1, a diagram of an exemplary environment 100 for application of the method and apparatus for diagonal lane detection is shown. A road surface is shown 110 having a left lane marker 120 depicted by a solid white line and a right lane marker 130 depicted by a broken white line. The intended driving lane is bounded by the left lane marker 120 and the right lane marker 130. Further depicted is a diagonal line 140 running across the intended driving lane. This causes a problem for the vehicle control system because it may detect the diagonal line 140 as an actual lane marker. The system may then follow the diagonal line 140 into an adjacent lane thereby resulting in an unintended lane change.

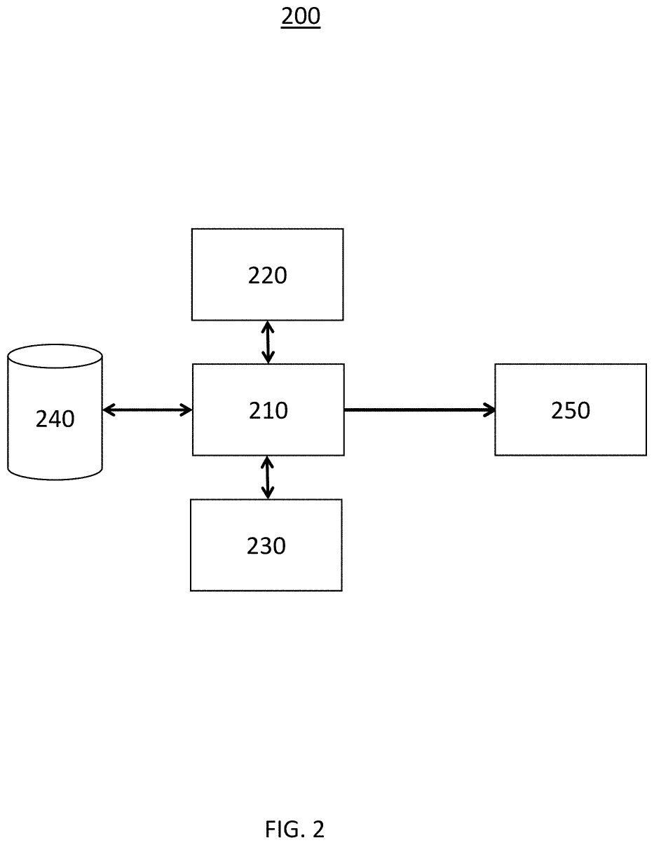

Turning now to FIG. 2 a block diagram illustrating an exemplary implementation of an apparatus 200 according for diagonal lane detection is shown. The exemplary apparatus has a processor 210, a camera 220, an antenna 230, a memory 240 and a vehicle control system 250. The antenna 220 may include an number of antenna elements for different frequency bands and polarizations and is used to transmit and receive data from external sources, such as global positioning system satellites, cloud servers, etc. The data may include map data used by the processor 210 to generate data to couple to the vehicle control system 250. This map data may include topographical data, road locations, speed limit information, traffic signal information, such as stop signs and yield signs and the like. The global positioning system data may be used to determine a vehicles location, direction and/or velocity with respect to the map data. The memory 240 may be used to store the received map data and the like.

The camera 220 is used to gather video data about proximate objects to the vehicle, weather conditions, and exact locations and orientations with respect to the map data and the global positioning system data. For example, the video data may be used to determine a location of the vehicle between lane markers which may be used by the processor 210 and the vehicle control system 250 in order to center the vehicle within a lane. The video data may also be used to identify other vehicles traveling near the vehicle, pedestrians, potholes and other obstacles. These obstacles may be dynamic or recent and therefore cannot be adequately represented by the map data.

The camera 220 may further be used to provide images capturing lane markers, which may be used to keep an autonomous or semiautonomous vehicle within the lane during operation. For example, the camera may record an image of a field of view from a forward facing camera. The image is coupled to the processor 210 which may be used to determine a first distance from the vehicle center to a left lane marker and a second distance from the vehicle center to a right lane marker. The processor 210 would then generate control data to couple to the vehicle controller in order to center the vehicle within the lane by making the first distance approximately equal to the second distance.

A problem may occur when the detected left lane marker and the detected right lane marker appear to merge. This may occur when a prior lane marker had not been removed from the road surface, such as a temporary construction lane indicator, or when a shadow or bright light creates a pattern on the road surface that the processor may determine is a lane marker. The currently disclosed method and apparatus are operative to detect when one of the lane markers is moving diagonally across the lane while the other lane marker is moving straight.

Diagonal lane is detected when the current lane heading point (CLHP) is bigger than a history buffer of Heading Point by a cal. A cal is a table with input of forward velocity times map curvature which checks that one lane line moving towards the other & rationalizes against the map. In addition, diagonal lane is detected when the beginning of the history buffer of the lane heading point contains a value smaller than a calibratable value, thereby checking that the moving lane line started at a reasonable pint, and that the CLHP of the other lane is smaller than a history buffer of heading points by a cal, thereby checking that the other lane is heading as expected.

In an exemplary embodiment, the left heading point may be determined by multiplying the left heading by a control point, the left curvature by the control point squared, the left delta curvature by the control point cubed and adding the three results. Likewise, the right heading point may be determined my multiplying the right heading by a control point, the right curvature by the control point squared, the right delta curvature by the control point cubed and adding the three results. The exemplary embodiment to determine the heading point is described by the following formulas.

HeadingPoint_{Left}=Heading_{Left}*CntrlPnt+Curvature_{Left}*CntrlPnt²+DeltaCurvature_{Left}*CntrlPnt³

HeadingPoint_{Right}=Heading_{Right}*CntrlPnt+Curvature_{Right}*CntrlPnt²+DeltaCurvature_{Right}*CntrlPnt³

I used

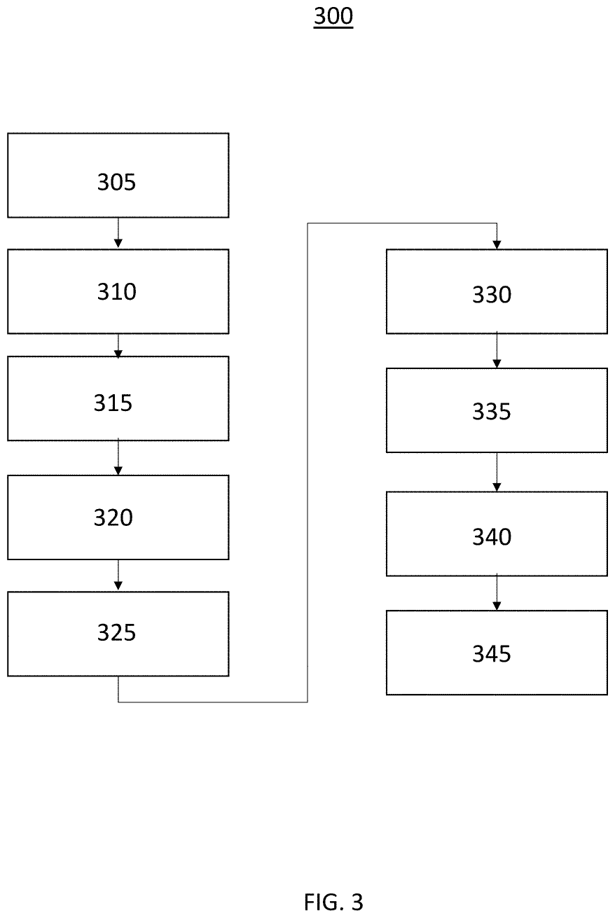

Turning now to FIG. 3, a flowchart illustrating a method 300 for diagonal lane detection according to an exemplary embodiment of the present application is shown. The method is operative to first receive a map data 305. This map data may be received though a wireless receiver and be transmitted by a central server that maintains updated and current map data. The map data may be received via a cellular network transmission, satellite transmission, or other wireless transmission. In addition, the map data may be periodically updated by software version upgrade or the like.

The method is then operative to detect a first lane heading 310 using sensor data received from a sensor package or data generated in response to sensor data. The data may include LIDAR range data, image data generated by a camera, a three-dimensional range map generated in response to multiple images or in response to a combination of LIDAR, RADAR and/or image data.

The method is then operative for generating an expected first lane heading in response to the map data and a previous first lane heading 315. The previous first lane heading may be determined in response to data stored in a memory and may be a detected first lane heading or a calculated first lane heading from a previous iteration of the method. A first deviation from the detected first lane heading and the expected first lane heading is then calculated 320. The first deviation may be a distance, an angle, or similar measurement, wherein the detected first lane heading does not correlate with an expected first lane heading. This first deviation may be indicative of a diagonal lane detection and therefore, the deviation is compared to a threshold value. A deviation exceeding the threshold value may be indicative of an erroneous lane marker detection. In an exemplary embodiment, a diagonal lane detection may be conditioned on the occurrence that the detected lane heading deviates toward the other detected lane heading. For example, if the first detected lane heading on the right side of the vehicle deviates away from the second detected lane heading on the right side of the vehicle, this may not be indicative of a diagonal lane marker, but may indicate the start of an exit lane or the like.

The method is then operative to detect a second lane heading 320 using sensor data. An expected second lane heading is then generated in response to the map data and a previous second lane heading 325. A second deviation is then determined in response to the second lane heading and the expected second lane heading 330. The first deviation and/or the second deviation are then compared to thresholds 335. If one of the deviations exceeds the threshold on one of the first lane heading or the second lane heading, a diagonal lane may be present. The method is then operative to generate a first vehicle heading in response to the lane heading that does not deviation more than the threshold and the map data 340. The vehicle heading may then be used by a vehicle control system 345 in order to control an autonomous vehicle. For example, the vehicle heading may be coupled from the processor to a vehicle control system via a data bus, such as a controller area network (CAN) bus, and used by the vehicle control system to steer an autonomous vehicle.

In an exemplary embodiment, if the second lane heading deviates from the expected lane heading by more than one meter, the method is operative to determine if the previous second lane heading deviated from the previous expected second lane heading by more than one meter. If the previous expected second lane heading did not deviate by more than the threshold, the method is then operative to compare a first lane heading, which does not deviate from an expected first lane heading more than the threshold, to the map data, wherein the map data is indicative of a lane heading.

In an exemplary embodiment, the method may be operative to detect a third lane heading and a fourth lane heading. From the third lane heading and the fourth lane heading the method may then be operative to determine a fourth deviation between the fourth lane heading and an expected fourth lane heading wherein the fourth deviation exceeds the threshold value. The method may then generate a second vehicle heading in response to the third lane heading and the first vehicle heading which is then coupled to a vehicle controller in order to control a vehicle.

In another exemplary embodiment, the method is operative to determine that a current lane heading point has deviated from a vehicle heading point by a distance greater than a first threshold. The method then determines if at a previous time increment that the previous heading point was within a reasonable distance from the vehicle heading point. The method then determines if the current land heading point is within a reasonable distance of the vehicle heading point. The method is then operative to set the diagonal lane weight to 0 and follow the other lane marker and/or the camera lane center estimation.

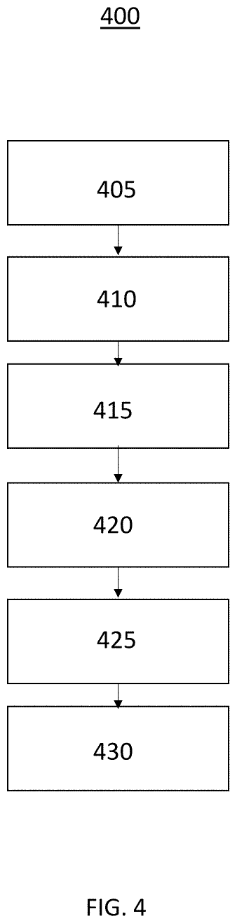

Turning now to FIG. 4, a flowchart illustrating a method 400 for diagonal lane detection according to another exemplary embodiment of the present application is shown. The method is operative to initially receive a map data 405 indicative of the location or roads, intersections, obstacles and more. The map data may also include information such as construction sites, accidents, narrow lanes, lane closures, road closures potholes, points of interested and other geographical data. The method is then operative to detect a first lane heading and a second lane heading 410. The second lane heading is then compared to a previous second lane heading to generate a calibration factor 415. The calibration factor is then compared to a threshold 420, wherein a vehicle heading is generated in response to the first lane heading and the first map data 425 in response to the calibration factor exceeding a threshold. The generated vehicle heading is then coupled to a vehicle controller, or the like, for controlling a vehicle 430.

The method may further include the steps of detecting a third lane heading and a fourth lane heading, determining a second calibration factor in response to the fourth lane heading and an expected fourth lane heading, generating a second vehicle heading in response to the third lane heading and the vehicle heading, and controlling the vehicle in response to the second vehicle heading.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links.

1. A method comprising:
receiving a map data;
detecting a first lane heading;
generating an expected first lane heading in response to the map data and a previous first lane heading;
determining a first deviation between the first land heading and the expected first lane heading wherein the first deviation is less than a threshold value;
detecting a second lane heading;
generating an expected second lane heading in response to the map data and a previous second lane heading;
determining a second deviation between the second land heading and the expected second lane heading wherein the second deviation is greater than a threshold value;
generating a first vehicle heading in response to the first lane heading and the expected second lane heading; and
controlling a vehicle steering in response to the first vehicle heading.

2. The method of claim 1 further comprising:
detecting a third lane heading
detecting a fourth lane heading
determining a fourth deviation between the fourth lane heading and an expected fourth lane heading wherein the fourth deviation exceeds the threshold value;
generating a second vehicle heading in response to the third lane heading and the first vehicle heading.

3. The method of claim 1 wherein the map data includes road information and lane information.

4. The method of claim 1 wherein the second deviation deviates from the expected second lane heading in a direction towards the first lane heading.

5. The method of claim 1 wherein the vehicle is an autonomous vehicle.

6. The method of claim 1 wherein the first lane heading and the second lane heading are detected in response to an image generated by a camera.

7. The method of claim 1 wherein the first lane heading and the second lane heading are detected in response to an image generated by a LIDAR system.

8. An apparatus comprising:
a receiver for receiving a map data;
a sensor for detecting a first lane marker and a second lane marker;
a processor for calculating a first lane heading in response to the first lane marker and a second lane heading in response to the second lane marker, comparing the second lane heading to a previous second lane heading to generate a calibration factor, generating a vehicle heading in response to the first lane heading and the first map data in response to the calibration factor exceeding a threshold; and
a controller for adjusting a vehicle steering in response to the vehicle heading.

9. The apparatus of claim 8 wherein the processor is further operative to:
calculate a third lane heading and a fourth lane heading,
determine a second calibration factor in response to the fourth lane heading and an expected fourth lane heading;
generate a second vehicle heading in response to the third lane heading and the vehicle heading; and
wherein the controller is further operative to control the vehicle in response to the second vehicle heading.

10. The apparatus of claim 8 wherein the map data includes road information and lane information.

11. The apparatus of claim 8 wherein the second lane heading deviates from the previous second lane heading in a direction towards the first lane heading.

12. The apparatus of claim 8 wherein the vehicle steering is a component of an autonomous vehicle

13. The apparatus of claim 8 wherein the sensor is a camera.

14. The apparatus of claim 8 wherein the sensor is a LIDAR.

15. A method comprising
receiving a first map data;
detecting a first lane heading and a second lane heading;
comparing the second lane heading to a previous second lane heading to generate a calibration factor;
generating a vehicle heading in response to the first lane heading and the first map data in response to the calibration factor exceeding a threshold; and
controlling a vehicle in response to the vehicle heading.

16. The method 15 further comprising:
detecting a third lane heading and a fourth lane heading,
determining a second calibration factor in response to the fourth lane heading and an expected fourth lane heading;
generating a second vehicle heading in response to the third lane heading and the vehicle heading; and
controlling the vehicle in response to the second vehicle heading.

17. The method of claim 15 wherein the vehicle is an autonomous vehicle.

18. The method of claim 15 wherein the first map data includes road information and lane information.

19. The method of claim 15 wherein the first lane heading and the second lane heading are detected in response to an image generated by a camera.

20. The method of claim 15 wherein the second lane heading deviates from the expected second lane heading in a direction towards the first lane heading
